(19) United States
(12) Patent Application Publication
(10) Pub. No.: US 2004/0103808 A1
(43) Pub. Date: Jun. 3, 2004

(54) Electrical circuits and methods of manufacture and use

(76) Inventors: Darren Lochun, Milford, NH (US); Robert Menize, Bennington, NH (US); Sally Durand, Hudson, NH (US); Eitan C. Zeira, Hollis, NH (US); Robert Pernice, Carlisle, MA (US)

Correspondence Address: TESTA, HURWITZ & THIBEAULT, LLP, HIGH STREET TOWER, 125 HIGH STREET, BOSTON, MA, 02110, US

(21) Appl. No.: 10/643,753

(22) Filed: Aug. 19, 2003

Related U.S. Application Data
(60) Provisional application No. 60/404,429, filed on Aug. 19, 2002.

(51) Int. Cl. B41C 1/00

(52) U.S. Cl. 101/483

(57) ABSTRACT

An electrical circuit is provided with a substrate, preferably of synthetic polymer or coated paper, and an electrical circuit letterpress printed onto the substrate from ink comprising of electrical particles suspended in a resin. The resin may be an organic resin such as a soy resin, and the electrical particles may be electrically conductive such as metallic silver. The manufacture of conductors, resistors, capacitors and other electrical components is proposed. The circuit printing process is reliable and comparatively inexpensive and does not suffer from the inherent limitations of other additive printing processes.

This application claims priority to U.S. Provisional Patent Application Serial No. 60/404,429 filed on Aug. 19, 2002, the entire disclosure of which is incorporated by reference herein.

### FIELD OF THE INVENTION

The present invention relates generally to circuit elements, and more specifically, to methods and apparatus for forming a circuit element including one or more conductive traces printed by a letterpress printing technique.

### BACKGROUND OF THE INVENTION

Printed circuits have been produced via many printing methodologies. The following patents point to a myriad of techniques and equipment that can deposit patterns of conductive inks, typically silver based, used as interconnects, antennas, and various passive circuit elements: U.S. Pat. Nos. 2,823,146, 3,879,572, 4,248,921, 4,368,281, 4,581,301, 4,682,415, 4,470,883, 4,522,888, 4,670,351, 5,733,598, 5,461,202, 6,027,762, 5,763,058, 6,010,771, 5,403,649, 5,437,916, 5,227,223, 6,252,550, 6,407,706, 6,356,234, 6,166,915, 6,137,687, 6,084,007, 5,366,760, 5,681,441, 6,150,07, and European Patent No. EP 615 256. Also, a number of the above patents suggest various enhancements in conductivity such as electroless and electroplating onto the printed lines. Although screen-printing is the predominant method of choice, gravure, flexography, and offset lithography have been shown to be viable printing methods to produce sufficiently conductive traces in production volumes.

All print methods offer the ability to transfer an image from a plate to a substrate. The medium they use is ink. Different printing methods vary according to the speed, ease of use, resolution and cost. Not all print methods are suitable for every task and many have developed niche areas to serve. Different types of printing methods generally require a unique rheology of the ink. When designing a conductive ink with a high loading of pigment, deficiencies in some of the print methods are immediately apparent.

Flexography offers a relatively poor image quality and does not handle highly pigmented ink well, due to the inherent Theological challenges of highly pigmented ink. Gravure utilizes a similar ink train but the image is engraved directly into the roll. This improves the image quality but raises tooling costs and still encounters a similar restriction on the rheology of the ink.

Wet-offset Lithography, which is a planar printing technology, can accommodate paste inks in the ink train and uses the hydrophilic/hydrophobic interaction of the printing plate to define the image. This interaction with water does result in runability issues as the emulsification of the ink causes ink to pile on the offset blanket, and can tint or tone the non-image areas of the plate with continued use.

Waterless lithography defines the image area using a silicone plate with differing regions of hydrophilicity but the technology is restricted to UV curing chemistry which has been demonstrated to limit the conductivity of a conductive trace.

Screen printing has been the staple printing technology used in the electronics industry. The major limitations of this technology are its speed and the fact that it lays down significantly more ink than any other print method raising the cost. Resolution is also seen to be an issue. Though screens have been produced of fine linescreen they are not cost effective or in widespread use.

Letterpress although mentioned as a possibility in several patents, e.g., U.S. Pat. Nos. 4,368,281 and 6,150,071, has not proven to be particularly advantageous in the production of printed circuits. Letterpress is an older printing technique and has largely been replaced in the market with other printing methods. The main reason is that presses for flexography and wet-offset lithography have become much cheaper and easier to use with simpler ink delivery systems and wider availability of different form factors such as cylinder diameters and anilox rolls.

Conductive traces typically are applied to a substrate, e.g., a printed circuit board (PCB) substrate such as FR4, using photolithography techniques that require many steps, including applying a resist, masking and etching. These steps often use chemicals that are harmful to the environmental. Conductive traces printed on substrates using printing presses typically are unstable and detach from the substrate when exposed to further processing, e.g., plating baths and solder reflow. The conductive traces also are typically not capable of being electroplated as they lack sufficient conductivity and first must be electrolessly plated, which is expensive as it requires two plating steps and is environmentally unfriendly. There exists a need for circuit elements and methods of manufacture that permit printing of conductive traces using printing presses, where the conductive traces are stable and receptive to further processing steps, (e.g., capable of being electrolytically plated), and are resistant to environmental conditions such as temperature, humidity and elongation (stress). The present invention addresses these needs and provides additional benefits and improvements.

### SUMMARY OF THE INVENTION

A novel approach to the manufacture of circuit elements has now been discovered. The advantages of the present invention include stable and well-adhered conductive traces that can be printed using commercial letterpress printing presses and can withstand further use and processing such as plating and solder reflow.

In one aspect, the invention features a method of forming an electrical circuit. The method includes providing a substrate, a letterpress printing plate, and an electrically pigmented ink. A trace is formed by letterpress printing the electrical pigmented ink onto the substrate. The electrical pigment of the ink may be a conductive pigment, a resistive pigment or a dielectric pigment. The conductive pigment is employed to form a conductive trace, the resistive pigment forms a resistor, and the dielectric pigment forms a passive component of the electrical circuit.

In certain embodiments, the electrically pigmented ink is printed onto the substrate. The substrate is, for example, an elastic substrate. The other embodiments, the substrate is formed of a material that resists ink debossing. The durometer of the printing plate is selected to maximize ink transfer onto the surface of the substrate. In certain embodiments of the method of forming an electrical circuit, the printing plate is disposed on a plate cylinder, the substrate is disposed on an impression cylinder and one or more bearers are disposed between the plate cylinder and the impression cylinder.

In other embodiments, the method of forming an electrical circuit includes providing a substrate, a letterpress printing plate, an electrically pigmented ink and an offset blanket cylinder. A trace is formed by letterpress printing the electrically pigmented ink onto the offset blanket cylinder. The offset blanket cylinder may be, for example, non-compressible. In certain embodiments, the printing plate is disposed on a plate cylinder, the substrate is disposed on an impression cylinder and one or more bearers are disposed between the plate cylinder, the offset cylinder and the impression cylinder.

### DESCRIPTION OF THE DRAWINGS

The invention is pointed out with particularity in the appended claims. The drawings are not necessarily to scale, emphasis instead generally being placed upon illustrating the principles of the invention. The advantages of the invention can be better understood by reference to the description taken in conjunction with the accompanying drawings.

FIGS. 1A and 1B are a plan view and a cross-sectional side view taken along line B-B, respectively, of an exemplary circuit element formed in accordance with the present invention;

Like reference characters in the respective drawn figures indicate corresponding parts.

### DETAILED DESCRIPTION OF THE INVENTION

The invention relates to an electrical circuit and a method of forming the electrical circuit by printing electrically pigmented ink using commercial letterpress printing presses to form a trace. The letterpress plate may print electrically pigmented ink onto a substrate. Alternatively, the electrically pigmented ink may be printed onto an offset blanket cylinder, which enables greater control over the impression settings to the substrate.

Letterpress has a limited number of variables that allows for faster set-up and more productive run time than other print methods that require constant maintenance and are more influenced by their environment. Letterpress can also be offset to a blanket cylinder to enable greater control over the impression settings to the substrate. This is known as letterset or dry offset.

Letterpress printing relies on a raised image plate where the print image is defined by photo-fixing the image through a mask, a method common to all printing plates, the unfixed area is removed by washing and light abrasion, leaving a raised image. The difference between letterpress and flexography, which also uses a raised image plate, are multifold.

Letterpress has a number of advantages when trying to print heavy load metallic inks requiring high resolution and high conductivity. Letterpress presses are designed to use paste inks and have an ink train of a similar configuration to lithographic printing presses. Conversely, flexography relies on inking the plate via an anilox roller, a precision engraved roll, which restricts the rheology of the ink. Consequently, letterpress inks are able to incorporate a much higher % w/w of a conductive particle than flexographic ink. This is critical when aiming for the greatest possible print resolution and the greatest ink transfer while maintaining maximum conductivity.

Letterpress plates typically are of a harder durometer than flexographic plates. Indeed, flexography has been described as a soft touch system. The high durometer plates allow accurate transfer of images while the ink train allows for highly metered and consistent ink delivery necessary for the type of conductivity consistency required for downstream processes such as electrolytic plating. This allows for a greater amount of pressure to be placed on the substrate during printing allowing for a better ink transfer than flexography.

Letterpress printing, because of the printing pressures and plate durometers involved, prints a debossed imaged. That is, the pressure of the inked plate to the substrate recesses the printed ink below the level of the substrate surface. Unlike most other printing processes, flexography, by using a soft touch system, does not deboss the printed ink, but, as a result, flexography image quality is poorer.

Throughout the description, where compositions are described as having, including, or comprising specific components, or where processes are described as having, including, or comprising specific process steps, it is contemplated that compositions of the present invention also consist essentially of, or consist of, the recited components, and that the processes of the present invention also consist essentially of, or consist of, the recited processing steps.

It should be understood that the order of steps or order for performing certain actions are immaterial so long as the invention remains operable. Moreover, two or more steps or actions may be conducted simultaneously.

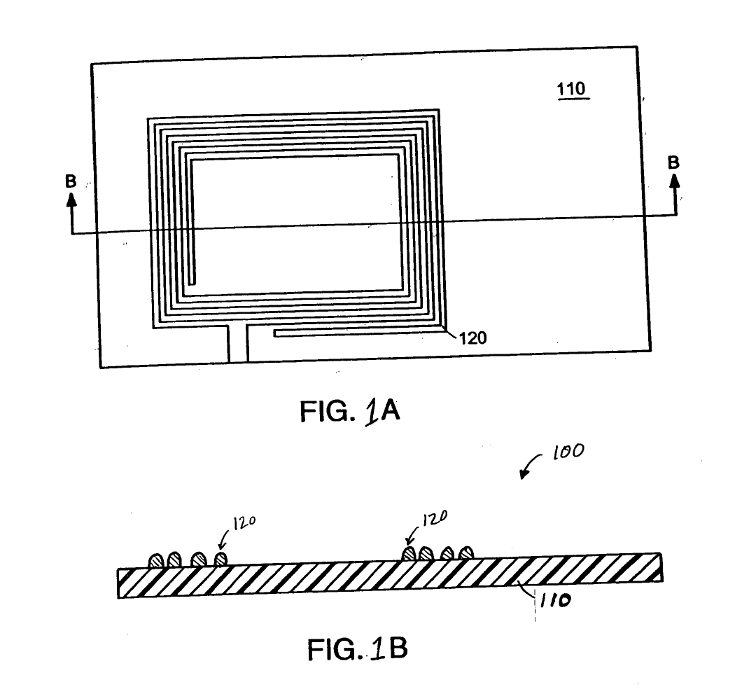

FIGS. 1A and 1B are a plan view and a cross-sectional side view taken along line B-B, respectively, of an exemplary circuit element formed in accordance with the present invention. In general overview, the circuit element 100 includes a thermoplastic substrate 110, and a conductive trace 120 disposed atop the surface of thermoplastic substrate 110. The conductive trace is neither depressed nor recessed within the thermoplastic substrate, rather the conductive trace 120 is disposed on the surface of the thermoplastic substrate 110. In FIGS. 1A and 1B, an RFID tag is depicted, however, according to the methods of the invention, any suitable pattern can be printed

A method of the invention generally includes: providing a substrate and printing a trace of electrically pigmented ink on the substrate using a letterpress printing technique.

The invention comprises multiple aspects that enable letterpress printing to be successfully employed in the manufacture of electrical circuits. The substrate may include certain polymer films or specialist coatings containing organic monomeric and/or inorganic chemicals to promote adhesion, that offer an elastic surface whereby the surface is not deformed upon printing at the required pressure for adequate ink transfer. One of the greatest consistencies in letterpress printing is the debossing of the printed image. That is, the printed image generally is lower than the level of the substrate surface, due to the pressure of the inked plate to the substrate. While this is of little consequence to the graphics arts printer it can be a fundamental problem when attempting to print an image suitable for the electronics industry. Recessed or depressed images in the substrate will lead to processing problems downstream, for example contacting electrodes for electrolytic plating and component attachment.

Suitable substrates include thermoplastic substrates that can be formed from thermoplastic polymers which include ethylene vinyl acetate, ethylene ethyl acetate, polyethylene, polypropylene, polycarbonate, polyimide, polyethylene naphthalate, polyphenylene sulfide, polyester, synthetic paper, polystyrene, and copolymers and combinations thereof.

The circuit element can further include a second substrate, wherein the second substrate is disposed adjacent to the thermoplastic substrate and opposite the conductive trace. The thermoplastic substrate can be hot melt coated, co-extruded or laminated onto the second substrate. The second substrate can be a second thermoplastic substrate having a second softening temperature that is higher than the softening temperature of the thermoplastic substrate. For example, the thermoplastic substrate can be formed from ethylene vinyl acetate, ethylene ethyl acetate, polyethylene, polypropylene, polycarbonate, copolymers or combinations thereof, and the second substrate can be formed from polyimide, polyethylene naphthalate, polyphenylene sulfide, polyester, synthetic paper, polystyrene, or copolymers thereof. The second substrate also can be formed from metal, metal foils, paper, glass, silica, and combinations thereof.

The circuit element can further include a third substrate disposed adjacent to the second substrate opposite the thermoplastic substrate. The third substrate can be a thermoplastic substrate. Optionally, a conductive trace can be at least partially embedded in the first, second, and/or third thermoplastic substrate. In a certain embodiment, after the trace is disposed on the substrate according to a letterpress printing technique, the trace is embedded into the substrate layer. The trace may be embedded or partially embedded into the substrate according to the techniques described in, U.S. Published application Ser. No. 20020,171,065A1 published on Nov. 21, 2002.

The method can include cross-linking the thermoplastic substrate after letterpress printing the conductive trace onto the thermoplastic substrate. The thermoplastic substrate can be cross-linked by electron beam radiation. The method also can include printing solder onto the thermoplastic substrate, adding electrical components to the thermoplastic substrate, and heating the solder to a reflow temperature. The method can include electrolytically plating the conductive trace to form electrolytic conductive plating on the conductive trace and/or coating a surface of the circuit element with a protective coating.

The thermoplastic substrate, the second substrate and any additional substrates (collectively the “substrate layers”), can include any substrate layer that can be used to construct a circuit element. The substrate layers can be provided as individual sheets so that they can be used in a sheet fed process, or as continuous sheets so that they can be processed in a reel to reel or roll to roll process. The substrate layers also can be provided as individual sheets adhered to a continuous film, e.g., by adhesion, co-extrusion or lamination, for processing in a continuous fashion in a commercial printer. The substrate layers can be of any thickness. Preferably, the substrate layers are together thin and flexible enough to be printed in a commercial printer and otherwise processed in a continuous fashion.

The substrate layers can be affixed together by various methods known in the art, including, but not limited to, use of adhesives, coating including bar coating and hot melt coating, hot melt extrusion, laminating including heat laminating, and co-extrusion. In a preferred embodiment, the substrate layers are co-extruded. Further substrate layers can include additional thermoplastic substrate layers that also can include conductive traces partially embedded therein, e.g., to provide a double-sided circuit board. Further substrate layers additionally or alternatively can include internal layers, e.g., dielectric layers such as conventional silica wafers, coated, printed, or laminated on both sides with a conductive material to provide desired mechanical or electrical properties. The substrate layers and/or multiple circuit elements of the present invention can be combined, e.g., to form a multi-layer circuit board. The substrate layers can include a composite such as glass fiber or paper impregnated with epoxy resins. The substrate layers also can include other additives, e.g., to improve fire retardancy, mechanical strength, thermal strength, and/or dielectric properties.

The thermoplastic substrate can be formed from any thermoplastic including, but not limited to, polyester, polyimide, polyethylene naphthalate, polyphenylene sulfide, synthetic papers, polyethylene, polypropylene, polycarbonate, ethylene vinyl acetate, ethylene ethyl acetate, and copolymers and combinations of these polymers. The thermoplastic substrate can include other materials to increase mechanical strength, to adjust dielectric properties, and/or to render the substrate flame retardant. The substrate layers readily can be chosen by the skilled practitioner depending on the properties desired for the electrical circuit element. For example, if it is desired to construct an electrical circuit element requiring flexibility, tear resistance, and high temperature stability, a second substrate formed from polyimide or polyethylene naphthalate can be employed that is coated with a desired elastic thermoplastic substrate. If it is desired to create a moisture barrier, a second substrate that is a metal or a metal foil can be employed.

A preferred thermoplastic polymer is ethylene vinyl acetate. Another preferred thermoplastic polymer is ethylene ethyl acetate. Suitable two-layer substrates include polyester substrates hot melt coated with ethylene vinyl acetate manufactured by General Binding Corporation (Skoke, Ill.), and commercially available from McIntire Business Products (Concord, N.H.). For example, the 5 mil product that includes a 3 mil polyester layer hot melt coated with a 2 mil ethylene vinyl acetate layer, and the 3 mil product that includes a 1 mil polyester layer hot melt coated with a 2 mil ethylene vinyl acetate layer, are suitable for use in accordance with the present invention. Suitable polyethylene naphthalate layers are available under the mark Kaladex® by I.E. du Pont de Nemours and Company (Circleville, Ohio). Suitable polyimide layers are available under the mark Kapton® by I.E. du Pont de Nemours and Company (Circleville, Ohio).

Synthetic papers are papers that include thermoplastic polymers that are ground or made into fibers and processed in a paper machine. Suitable synthetic papers for use in accordance with the circuit element and methods of the present invention include, but are not limited to, POLYART® clay coated polyethylene synthetic paper from Arjobex North America (Charlotte, N.C.), and TESLIN® silica and polyethylene synthetic printing sheets from PPG (Vernon Hills, Ill.).

Suitable second and third substrates can include substrates formed from polyimide, polyethylene naphthalate, polyphenylene sulfide, polyester, synthetic paper, polystyrene, and copolymers and combinations thereof. Second substrates also can include metal, metal foils, paper, glass, silica, and combinations thereof. For example, a thermoplastic substrate can include a second substrate disposed adjacent to the thermoplastic substrate. The second layer can be polymeric or non-polymeric, such as silica. The layers can be affixed to each other using various techniques known in the art, such as hot melt coating, lamination, coextrusion, bar coating, or adhesion. Preferably, the thermoplastic substrate is formed from ethylene vinyl acetate or ethylene ethyl acetate, and it is coextruded or hot melt coated to a second substrate formed from polyester. Hot melt coating refers to extruding a molten polymer layer onto a moving substrate. Alternative methods of coating include curtain coating and bar coating. The substrate layers preferably are in web form so that they easily can be stored and shipped before and/or after they are incorporated into the circuit elements of the present invention, and so that they can readily be fed through a continuous process, e.g., a roll to roll process or a sheet fed process.

The letterpress printing plates are available in a range of profiles and durometers (hardness). While the majority of these letterpress printing plates are more than suitable for the visually accurate work that most printers require, for printed circuits a new level of accuracy is required. Print inaccuracy can arise from a multitude of sources but when considering printing electrical circuits two important parameters must be considered. For example, to maximize conductivity there must be a larger than normal transfer of ink from the letterpress plate to the substrate and the ink must be of uniform thickness throughout. Ink transfer is controlled by the ink fountain settings and by the amount of squeeze (pressure) to the substrate. There is a finite degree of control when adjusting ink fountain settings that does not allow for adequate control in all situations. If the plate material is of the incorrect durometer or the etched image profile is to high, then the amount of squeeze applied can have a detrimental impact on the image quality. A hardness profile ranging between 50 durometer and 100 durometer will minimize distortion and maximize ink transfer. Recent advances in photopolymer technology now overcome both of these problems. These new plates offer higher resolution and straighter edges than standard plate used today. The invention is in part the use of specific letterpress printing plates.

Cross-sections of the printed ink will typically show a profile where the ink applied to the plate is even but on impression to the substrate the ink spreads to the edges where it is concentrated. This is known as squeeze-out and can be exaggerated as print pressure increases. The invention is in part the innovation in generating computer designed letterpress plate artwork that limits the squeeze-out effect by lowering the density of the image (grayscale) where squeeze-out is greatest, i.e., at the edges. The image density of a given plate will range from about 5% to about 100% (e.g., no greyscale). In one embodiment, the density of the image at the center of the plate is about 100% and the density of the image about the perimeter of the plate is about 5% such that after print pressure is applied, the printed ink is evenly applied to the substrate. In another embodiment, the density of the image at the center of the plate is about 100) and the density of the image about the perimeter of the plate is about 45%.

The ability of letterpress printing techniques to precisely control the printing pressures applied when printing the electrically pigmented ink to form the trace greatly benefits the quality of the print process, which is of great importance for the quality assurance to the electronics industry. Bearers, which help prevent bounce and allow for controlled and even pressure distribution, are employed in accordance with the invention. Bearers may be positioned, for example, on one or both of the plate cylinder and the impression cylinder. Alternatively, one or more bearers may be positioned between the plate cylinder and the impression cylinder.

The electrically pigmented ink is formulated for letterpress printing such that the electrically pigmented inks display good print quality and resolution as well as demonstrating a superior electrical response. Electrically pigmented ink, containing pigments that give rise to electrical properties such as conductivity, resistance and capacitance, may be formulated for letterpress printing. When employed with letterpress printing, some Theological constraints (e.g., % w/w of pigment) of ink systems (e.g., inkjet, flexography and gravure) are removed. Gone too is the hydrophobicity issue of wet-offset lithography. In electrically pigmented ink formulation, more direction can be channeled to achieving good print quality while maximizing the desired electrical characteristic. It generally has been shown that as the %w/w of silver in conductive ink increases, the greater the resultant conductivity of a printed trace. Conductive pigments can include silver, gold, platinum, palladium, nickel, alloys of the above and carbon and its allotropes. Resistive pigments include carbon. Dielectric pigments include titanium dioxide, barium titanate, oxides of silicon, and metallic oxides such as aluminum. The rheological profile for letterpress permits use of very high viscosity inks, also, the % w/w loading of the pigments is not limited to the same extent as encountered with other printing methods (e.g., flexography).

Suitable conductive inks that may be employed in accordance with the invention include one or more resins and/or solvents. Various other ink additives known in the art, e.g., antioxidants, leveling agents, flow agents and drying agents, may be included in the conductive ink. The conductive ink can be in the form of a paste, slurry or dispersion. The ink generally also includes one or more solvents that readily can be adjusted by the skilled practitioner for a desired rheology. The ink formulation preferably is mixed in a grinding mill to sufficiently wet the conductive particles with the vehicle, e.g., solvent and resin.

The conductive material can include silver, copper, gold, palladium, platinum, carbon, or combinations of these particles. The average particle size of the conductive material preferably is within the range of between about 0.5 μm and about 20 μm. More preferably the average particle size is between about 2 μm and about 5 μm. Even more preferably, the average particle size is about 3 μm. The amount of conductive material in the conductive trace preferably is between about 60% and about 90% on a dry weight basis. More preferably, the amount of conductive material in the conductive trace is between about 75% and about 85% on a dry weight basis.

Optionally, the conductivity of the trace can be increased if the conductive trace includes a particle size distribution of conductive particles that does not have a Gaussian or normal distribution but a particle size distribution having at least two modes, e.g., bimodal and trimodal distributions. For example, a bimodal distribution of particles can increase the conductivity of the conductive trace because the smaller particles can fill in gaps between the larger particles and thereby decrease the distances over which electrons must travel between particles.

A bimodal distribution can be obtained, e.g., by mixing two particle mixtures, each having different mean particle sizes. One suitable conductive ink includes a mixture of two types of silver particles, each having different particles size distributions. The first is available under the trade designation RA15 from Metalor (Attleboro, Mass.), and has particles, 10% of which are equal to or less than 2.6 μm in size, 50% of which are equal to or less than 7.3 μm in size, and 90% of which are equal to or less than 16.3 μm in size. The second is available under the trade designation RA76 from Metalor (Attleboro, Mass.), and has particles, 10% of which are equal to or less than 2.5 μm in size, 50% of which are equal to or less than 10.1 μm in size, 90% of which are equal to or less than 22.9 μm in size, and 100% of which are equal or less than 62.2 μm in size. Of course, the particle size distribution can be trimodal and so on.

The conductive particles can be flakes and/or powders. Preferably, the conductive flakes have a mean aspect ratio of between about 2 and about 50, and more preferably between about 5 and about 15. An aspect ratio is a ratio of the largest linear dimension of a particle to the smallest linear dimension of the particle. For example, the aspect ratio of an ellipsoidal particle is the diameter along its major axis divided by the diameter along its minor axis. For a flake, the aspect ratio is the longest dimension across the length of the flake divided by its thickness.

Suitable conductive flakes include those sold by Metalor (Attleboro, Mass.), under the following trade designations: P185-2 flakes having a particle size distribution substantially between about 2 μm and about 18 μm; P264-1 and P264-2 flakes having particle size distributions substantially between about 0.5 μm and about 5 μm; P204-2 flakes having a particle size distribution substantially between about 1 μm and about 10 μm; P204-3 flakes having a particle size distribution substantially between about 1 μm and about 8 μm; P204-4 flakes having a particle size distribution substantially between about 2 μm and about 9 μm; EA-2388 flakes having a particle size distribution substantially between about 1 μm and about 9 μm; SA-0201 flakes having a particle size distribution substantially between about 0.5 μm and about 22 μm and having a mean value of about 2.8 μm; RA-0001 flakes having a particle size distribution substantially between about 1 μm and about 6 μm; RA-0015 flakes having a particle size distribution substantially between about 2 μm and about 17 μm; and RA-0076 flakes having a particle size distribution substantially between about 2 μm and about 62 μm, and having a mean value of about 12 μm. Suitable silver powders include those sold by Metalor (Attleboro, Mass.), under the following trade designations: C-0083P powder having a particle size distribution substantially between about 0.4 μm and about 4 μm, and having a mean value of about 1.2 μm; K-0082P powder having a particle size distribution substantially between about 0.4 μm and about 6.5 μm, and having a mean value of about 1.7 μm; and K-1321P powder having a particle size distribution substantially between about 1 μm and about 4 μm.

The resin in the conductive ink can include any resin including, but not limited to, polymers, polymer blends, and fatty acids. Alkyd resins can be used, including LV-2190, LV-2183 and XV-1578 alkyd resins from Lawter International (Kenosha, Wis.). Also suitable are Crystal Gloss Metallic Amber resin, Z-kyd resin, and alkali refined linseed oil resin available from Kerley Ink (Broadview, Ill.). Soy resins available from Ron Ink Company (Rochester, N.Y.), also are suitable.

Solvents for use in the conductive ink formulation are well known in the art and a skilled practitioner readily can identify a number of suitable solvents for use in a particular printing application. Solvents generally will comprise between about 3% and about 40% of the ink by weight on a wet basis. The amount will vary depending on various factors including the viscosity of the resin, the solvation characteristics of the solvent, and the conductive particle size, distribution and surface morphology for any given printing method. Generally, solvent can be added to the ink mixture until a desired ink rheology is achieved. The desired rheology depends on the printing method used, and are known by skilled printers and ink manufacturers. The solvent in the conductive ink can include non-polar solvents such as a hydrocarbon solvent, water, an alcohol such as isopropyl alcohol, and combinations thereof. Preferably, an aliphatic hydrocarbon solvent is employed. Examples of suitable solvents include Isopar H aliphatic hydrocarbon solvent from Exxon (Houston, Tex.); EXX-PRINTO M71 a and EXX-PRINT® 274a aliphatic and aromatic hydrocarbon solvent from Exxon Corporation (Houston, Tex.); and McGee Sol 52, McGee Sol 47 and McGee Sol 470 aliphatic and aromatic hydrocarbon solvent from Lawter International (Kenosha, Wis.).

The electrically pigmented ink preferably is deposited in a quantity such that the dried conductive trace is from about 1 μm to about 8 μm thick depending on the printing process used. A single impression giving an ink film thickness of about 2 μm to about 3 μm typically is sufficient to achieve sufficient conductivity for plating.

The conductive traces formed in accordance with the present invention can be formed at high resolutions and in intricate patterns. Printing presses have been used to print conductive traces that are capable of line widths and gaps of about 100 μm. It is envisioned that more intricate designs and smaller line widths can be achieved in accordance with the present invention depending on the printing equipment. The conductive trace can form or be part of an RFID tag, a printed wiring board, a printed circuit board, single layer or multi-layer, a passive component such as a resistor or capacitor, a touch pad, or the like. Numerous other applications, such as microwave antennas are contemplated by the present invention. The conductivity can be adjusted for various application, e.g., to tune an antenna, or to form a resistor or capacitor.

The conductive ink can be dried using an oven, such as a convection oven, or using infrared, and radio frequency drying. Preferably, the heating device is designed to allow the printed substrate to pass therethrough so that the conductive ink can be dried in a continuous manner to facilitate large-scale production. The drying temperature employed depends on the ink used, the softening temperature of the thermoplastic substrate, and the drying time or belt speed. Typical drying temperatures are from about 125° F. to about 150° F.

The adhesion of a conductive trace and/or any plating thereon can be determined by a standard tape test where Scotch® adhesive tape is applied to the circuit element, peeled off, and optically inspected for transfer of the conductive trace or plating from the circuit element to the Scotch® adhesive tape. The tape exerts a peel force on the conductive trace and/or any plating thereon of approximately 6 lb/in (1050 N/m). An adhesion of about 5 to about 7 pounds per square inch generally is considered acceptable for most uses of circuit elements.

Electrolytic plating also is called electrolytic conductive plating or electroplating, which means the electrolytic deposition or electrodeposition of a conductive material from a plating solution by the application of electric current. Conductive plating is formed from a conductive plating material. Suitable conductive plating materials include, but are not limited to, copper, nickel, gold, silver, palladium, and combinations of thereof. The conductive plating is preferably formed by electrolytically plating the conductive traces. Methods of electrolytic plating are known in the art. Preferably the conductive material in the conductive traces are silver particles and the conductive traces are electroplated with copper. Additionally, other types of plating can be used, e.g., electrochemical or electroless plating. Where increased conductivity is desired, methods of the instant invention can further include the step of electrolytically plating the conductive traces, e.g., with copper, to form conductive plating on the conductive trace. Plating can also provide the added benefit of bridging any small voids or gaps in the conductive trace.

Surface mounted devices can be incorporated into the circuit elements of the present invention. Such devices can be attached to the substrate layers by a pin, which can be affixed with solder, an electrically conductive adhesive, or the like. Solder or an electrically conductive adhesive and one or more vias also can facilitate electrical communication between devices and traces on both sides of the substrate. Additionally or alternatively, solder pads without vias can attach other surface mounted devices, and vias can be used to facilitate registration or communication between one or several substrates. Substrates can be stacked and even laminated to provide a multi-layer circuit board with surface mounted devices only on the outer layers.

Surface mounted devices can be mounted on a circuit element of the present invention. For example, solder in the form of a paste or ink can be applied to the circuit element to form solder pads at predetermined places where devices are to be mounted by conventional methods such as screen printing with a mask, solder paste, and squeegee. The surface mounted devices then can be placed on the circuit element at predetermined places dictated by the circuit design. The circuit element then can be passed through a reflow oven or furnace to melt or reflow the solder. Reflow temperatures vary depending on the solder formula, and typically are provided for commercial solders. Generally, the solder reflow temperature is about 250° C. When the circuit element is removed from the furnace and cools, the solder hardens and the devices are affixed to the board at the solder pads.

The thermoplastic substrate, a second layer and/or any additional substrate layers can be cross-linked prior to exposure to solder reflow temperatures or other high temperatures experienced in further processing and/or use. Cross-linking can be employed for various reasons, e.g., if any of the substrate layers cannot withstand the temperatures experienced in the reflow oven and/or if the reflow temperature might otherwise compromise the integrity of the traces and/or the substrate layers. The substrate can be cross-linked by a variety of known methods such as exposure to UV radiation, gamma radiation, and electron beam radiation.

A preferred method of cross-linking is electron beam radiation because it is self-propagating unlike other techniques, e.g., UV radiation that requires an initiator for cross-linking to occur. The circuit element can be exposed to electron beam radiation by passing it under or through an electron beam curing station. For example, the circuit element can be exposed to electron beam radiation from about 3 to about 7 MRads at a belt speed of 20 ft/min, but the exposure dosage and belt speed can be adjusted to accommodate the printing process used and the desired degree of cross-linking.

Thermoplastic substrates formed from ethylene vinyl acetate and ethylene ethyl acetate may be exposed to electron beam radiation at 5 MRads at a belt speed of 20 ft/min before exposure to a reflow oven. Prior to cross-linking, the substrate layers cannot withstand a reflow temperature of 250° C. and they warp and buckle upon exposure to the reflow temperature. After cross-linking, it is expected that the circuit element will not warp or buckle upon exposure to the reflow temperature.

Even if the circuit element will not be subjected to a reflow oven, if it must withstand high temperatures in further processing or in use, e.g., to increase environmental resistance in high temperature application or devices like an automobile engine, it can be cross-linked in the same fashion to increase its stability at high temperatures. There are numerous additional processing steps that the circuit elements of the present invention can be incorporated into, such as cropping and drilling, that are contemplated by the present invention.

The circuit element can be coated or plated with a protective coating formed from a polymer or metal, e.g., nickel, to protect the conductive traces, the conductive plating and/or other elements of the circuit element from corrosion or other damage. Suitable protective coating materials and methods of coating or plating are known in the art. Additionally or alternatively, both sides of the substrate can be coated with further protective coatings. Such coatings can be present only on the conductive traces or on predetermined sections of the circuit element.

Preferably, if the circuit elements are packaged, a release liner is placed between each circuit element to prevent the transfer of the conductive traces or the substrate layers if either or both are tacky. Circuit elements can be bundled and wrapped in shrink-wrap to discourage movement and damage to the circuit elements.

In one embodiment, letterpress printing is employed to make patterns defined to contribute to a functioning electrical circuit. These patterns can be formed from a conductor, resistor or a dielectric material to form passive components. In accordance with the invention, ink of appropriate rheology has conductive, resistive or dielectric properties when printed. A letterpress printing plate with a profile and durometer that will minimize distortion and maximize ink transfer is employed to transfer the ink and an elastic substrate, which will not deboss, receives the ink. In one embodiment, one or more bearers are employed between the plate cylinder and the impression cylinder. The bearers allow for even and controlled application of pressure. The artwork of the plate features a changing grayscale profile, which minimizes the impact of squeeze-out when pressure is applied to the plate.

In another embodiment, letterset (or dry offset) is employed to make printed patterns defined to contribute to a functioning electrical circuit. These patterns can be formed from a conductor, resistor or dielectric material to form passive components. In accordance with letterset (dry offset), an offset blanket cylinder with specified durometer will allow for controlled pressure of the ink to the substrate. Non-compressible offset blankets are employed to minimize image distortion. Suitable offset blanket cylinders are avialable from Day International (Dayton, Ohio) under the trade designation, dayGraphica™ 8212. Bearers may be used on the offset cylinder to provide even and controlled pressure between the plate cylinder, the offset cylinder and the impression cylinder.

It should be understood that the individual steps of the invention can occur simultaneously and/or in any order as long as the invention remains operable. The methods of the present invention can be used to create a conductive pattern on the surface of any circuit element including, but not limited to, conductors, resistors, capacitors, security tags, antennas, contacts, and lands. The circuit element can be or form part of a rigid, flexible or rigid-flex circuit layer. It can be incorporated into a single or double-sided circuit layer or assembly, a printed wiring board or wiring board assembly, or a multi-layer printed circuit or wiring board. In addition, methods of the present invention can be used to create conductive patterns on the surfaces of circuit elements to be used as internal and/or external circuit elements. The circuit elements of the present invention can be used in any application where circuit elements are used.

Each of the patent documents and scientific publications disclosed hereinabove is incorporated by reference herein for all purposes.

The invention may be embodied in other specific forms without departing from the spirit or essential characteristics thereof. The foregoing embodiments are therefore to be considered in all respects illustrative rather than limiting on the invention described herein. Scope of the invention is thus indicated by the appended claims rather than by the foregoing description, and all changes that come within the meaning and range of equivalency of the claims are intended to be embraced therein.

1. A method of forming an electrical circuit comprising the steps of:
providing a substrate; and, printing a trace of electrically pigmented ink on the substrate using letterpress printing technique.

2. The method of claim 1 wherein the substrate comprises an elastic material.

3. The method of claim 1 wherein the electrically pigmented ink comprises a conductive pigment, a resistive pigment or a dielectric pigment.

4. The method of claim 1 wherein the substrate resists ink debossing.

5. The method of claim 1 wherein the printing plate has a durometer that maximizes ink transfer onto the surface of the substrate.

6. The method of claim 1 further comprising one or more bearers employed with the letterpress printing technique.

7. The method of claim 1 further comprising:
providing a letterpress printing plate, wherein the printing plate image density limits electrically pigmented ink squeeze-out.

8. The method claim 1 wherein the letterpress printing technique comprises letterpress printing.

9. The method of claim 1 wherein the letterpress printing technique comprises letterset printing.
